(19) United States
(12) Patent Application Publication
(10) Pub. No.: US 2004/0071342 A1
(43) Pub. Date: Apr. 15, 2004

(54) Method of detecting and segmenting characteristic areas in a picture and use of the method

(76) Inventors: Peter Locht, Viby J. (DK); Peter Mikkelsen, Egaa (DK); Knud Thomsen, Aarhus C (DK)

Correspondence Address: MERCHANT & GOULD PC, P.O. BOX 2903, MINNEAPOLIS, MN, 55402-0903, US

(21) Appl. No.: 10/470,370

(22) PCT Filed: Feb. 25, 2002
(86) PCT No.: PCT/DK02/00126

(30) Foreign Application Priority Data
Feb. 26, 2001 (DK) PA 2001-00316

(51) Int. Cl. G06K 9/00; G06K 9/34

(52) U.S. Cl. 382/164; 382/133

(57) ABSTRACT

In a method of detecting and segmenting characteristic regions in an image, such as a colour image having characteristic regions, where the image is represented by a plurality of pixel values expressed in grey tones, a circle of radius r is defined for a plurality of pixel positions, which radius approximated is regarded as the radius of a characteristic region. The optimum value of radius r is determined by calculating, for a large number of possible values of r, the difference between the characteristic grey tone value of an outer zone having the radius range r1 to qr1 (=r2), where q is a constant, and the characteristic grey tone value of an inner zone having the radius range 0 to r1. Then the radius r1 providing the greatest difference is selected as the radius of the object. Further, the radius of the characteristic region is adjusted by an adjustment factor, and finally the characteristic region is divided into sectors, each of which is again subjected to a grey tone analysis, as mentioned above, following which the characteristic region is changed from being circular to being non-circular. The invention allows a very high degree of detail information of e.g. images that show cell cores in very small dimensions.

The invention relates to a method of detecting and segmenting characteristic dark regions in an image which is represented by a plurality of pixels having positions (x,y).

The invention moreover relates to a use.

Images represented by a plurality of pixel values, where each pixel has a colour value, may be subjected to a colour analysis for analysis of the image, as is known e.g. in connection with a colour analysis system which is described in DK 174419 B1.

This system is suitable for the analysis of image representations from a video camera of e.g. human or animal issue cells. The images from the video camera frequently have a very complex composition and may be difficult to interpret automatically.

In the use of the image analysis system according to the DK patent, complicated images may be transformed from containing a quantity of colours to containing e.g. four symbolic colours, thereby allowing information of even very complex images to be derived from the image.

In practice, an image of tissue with cell cores may be transformed by means of the colour analysis system according to the DK patent such that regions having possible cell cores are shown as a specific colour, e.g. yellow, while other regions in the image are shown by other colours.

An object of the invention is to analyze special regions of an image, which is e.g. formed as a transformed image in an image processing system. In other words, it is desirable to analyze some special regions of a transformed region in an image, which may be the regions mentioned above that appear as yellow regions of an image, and which may contain cell cores.

The object of the invention is achieved by a method of the type stated in the introductory portion of claim 1, which is characterized by comprising the steps of:

a) defining a given pixel position (x,y) as the centre of circular regions having radii r₁ and r₁, respectively, and perimeters P₁ and P₂, respectively, where r₁ and r₂ may assume a large number of values, with r₂>r₁>0,

b) calculating V₁ for each value of r₁ as an average of grey tone numbers for all circle perimeters P₁ in the range 0 to r₁,

c) calculating V₂ as an average of grey tone numbers for all circle perimeters P₂ in the range r₁ to r₂,

d) selecting the value of r₁ which gives the greatest value of V₂−V₁ as the radius of the object,

e) repeating steps a) to d) for a plurality of pixel positions in the image.

Hereby, specific dark regions in an image are defined as circular regions on the basis of the grey tone value distributions that are present in the characteristic regions of the image, the size of the individual circular regions being informative of regions in an image which has e.g. been subjected to a colour analysis, but which cannot be derived from the colour analysis alone.

It is expedient for reasons of calculation if, as stated in claim 2, the relation r₂=qr₁ is used between r₁ and r₂, where q is a number larger than 0.

A given pixel position, however, is now only accepted as the centre of an interesting circular area which is to be analyzed further, if, as stated in claim 3, a given pixel position is only accepted as the centre of a circular area, if a value of V₂−V₁ has been found. for this position which exceeds the corresponding values of all positions within said circular region, when these corresponding values are calculated according to steps a) to e) of claim 1, otherwise the method proceeds in another position.

With a view to providing a single expression of the grey tone values in a given circle perimeter, the grey tone number of a given circle perimeter P₁, P₂ may be determined as a specific percentile of all grey tone values in the perimeter, as stated in claim 4. In this context, percentile is taken to mean the grey tone value which is greater than P% of the grey tone values of all pixels on the perimeter.

With a view to reducing the number of calculations, it is an advantage if, as stated in claim 5, the percentile values of the individual circle perimeters are weighted relative to the perimeter length. This weighting may e.g. also be performed relative to the number of pixels that are present on the respective perimeters.

When, as stated in claim 6, only values of V₂−V₁ above a preselected value are used as the centre of a characteristic region, and, as stated in claim 7, circular regions having V₂ values above a predetermined threshold value are non-elected, the number of calculations may be reduced.

To achieve further resolution of the characteristic regions in an image, it is an advantage if, as stated in claim 8, the pixel position determined in steps a) to e) as the centre of a circular region is changed to the centre of gravity of the grey tone centre of gravity of the circle, thereby ensuring that in the cases where the grey tone values within each circle are not quite homogeneous, the first-calculated centre of the circular region is moved to the grey tone centre of gravity of the circle.

Moreover, it is expedient if, as stated in claim 9, the outer boundary of each characteristic region is divided into sectors, and the steps a) to d) are performed for the pixel values of each sector, following which the maximum values of the individual sectors are used for defining the outer part of these characteristic regions. The circle is hereby divided into sectors having their respective radii, and the resulting maximum values in the individual sectors determine the extent or pitch diameter of the individual sector.

As mentioned, the invention also relates to a use. This use is defined in claim 10.

The invention will now be explained more fully with reference to the embodiment shown in the drawing, in which

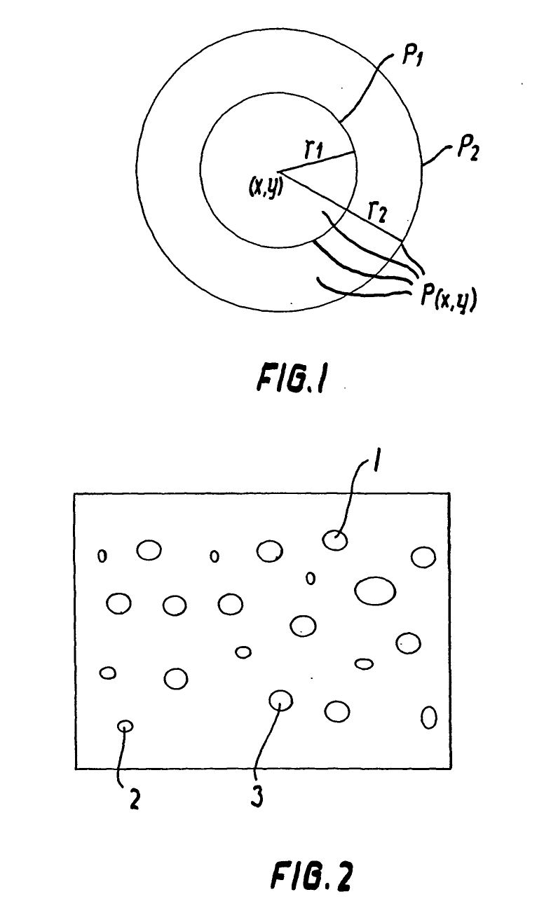

FIG. 1 shows the parameters included in the image analysis according to the invention, symbolically and in an enlarged view,

FIG. 2 schematically shows an image after a first part of the analysis according to the invention,

FIG. 3 schematically shows a first correction step in the analysis according to the invention,

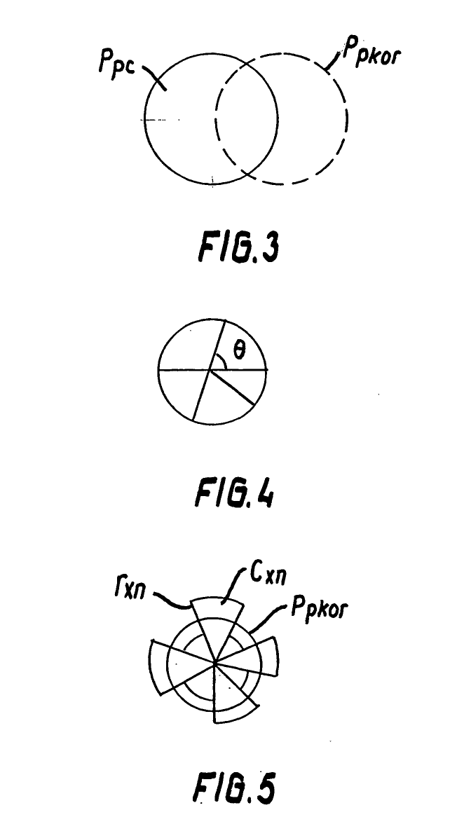

FIG. 4 schematically shows a second correction step according to the invention,

FIG. 5 schematically shows a third correction step,

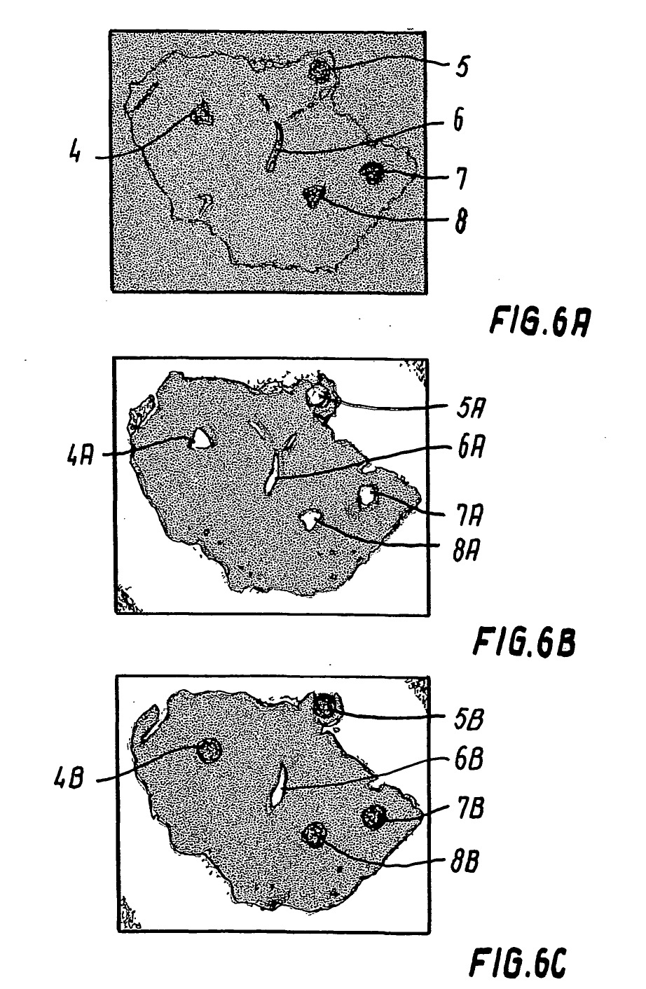

FIG. 6A shows an image of tissue cells that may be recorded with a digital camera in a microscope,

FIG. 6B shows the image of FIG. 6B after a colour processing analysis, while

FIG. 6C shows the image of FIG. 6B, but now after having been subjected to the image analysis according to the invention.

FIG. 1 schematically illustrates some pixel positions in an image, of which four in the figure are designated R(x,y) and one is designated C(x,y). Also the centre of two circles having radii r₁, r₂ and perimeters P₁ and P₂ are designated x,y.

According to the invention, a grey tone number V1 is determined as an average of all the pixels which are positioned on circles having a radius which is smaller than r₁, and which are positioned on the perimeters of the respective circles. Correspondingly, a grey tone number V2 is determined for all the pixels which are positioned on a radius which is larger than r₁, but smaller than r₂.

Put differently, V1 and V2, respectively, are calculated in that a grey tone number G₁ and G₂, respectively, is determined for each circle perimeter, and then V1 and V2, respectively, are determined by the relation

$$1 / n {\sum }_{12}^{n} Gn$$

where n is a plurality of perimeters.

The grey tone numbers G₁ and G₂ may e.g. be determined as a percentile of all grey tone values in the perimeter, where the values may e.g. be between 0 and 255, with 0 representing an entirely black value, and 255 representing an entirely white value.

Expediently, r₂ is set to r₁q, where q may e.g. assume the value 1, 2.

According to the invention, the difference V₂−V₁ is determined, and when the maximum value has been found, the radius r₁ is used, which is a characteristic region having the centre X,Y.

The above-mentioned procedure is repeated for a plurality of pixels in an image. When the procedure has been completed for a plurality of pixels in the image, the image is divided into a plurality of circles having different radii, as is shown in FIG. 2 in which the reference numerals 1, 2 and 3 show some circles which have been produced by means of the above-mentioned method.

If overlapping circles occur in the determination of the circles in FIG. 2, which may happen when two regions are close to each other, then the one of the overlapping circles determined as the one identified by its greatest V₂−V₁ will be selected, while the other will be deleted.

As will be seen from FIG. 2, the image has been divided into circular regions without overlap, where the circles have different radii, in accordance with the method of the invention.

To be able to process also the cases where the grey tone values within each circle are not quite homogeneous, the original centre of the circular region is moved to the grey tone centre of gravity of the circle. This does not involve any change in radius, but perhaps an adjustment of the centre, as shown in FIG. 3.

The effect of the correction method is illustrated in an enlarged view in FIG. 3, where it will be seen that the circle P_{pc} has been moved to a new position shown by the dashed circle Pₚₖₒᵣ.

To control and adjust the radius of the individual circles which has been brought about after the above-mentioned correction, each circle, as shown in FIG. 4, is divided into circular sectors of the angle q, which may e.g. have the value 360/32=11.25 (shown with a somewhat greater value in the figure for clarity).

Each circular sector is now processed independently by the same method as is described above for a full circle in the steps a-d, so that each circular sector is given the radius that results in the greatest value of V₂−V₁ for the sector, which takes place in a quite analogous manner, as explained in connection with FIG. 1 above.

By this method, the original circle is thus divided into circular sectors having different radii. This is illustrated in FIG. 5 in an enlarged view.

In FIG. 5, Ppkor designates a circle which has been produced by means of the image processing steps described above. A circular sector is Cₓₙ, and the radius rₓₙ of this circular sector has been provided in that each pixel value within the radius of the circular sector having Pₚₖₒᵣ as its perimeter, is subjected to the calculation as explained in connection with FIG. 1 and FIG. 2. The outer boundary of the circle Pₚₖₒᵣ is hereby adapted to the characteristic origin which is detected according to the invention.

FIG. 6A shows an ordinary image of tissue which contains some dark regions designated 4, 5, 6, 7, and 8. These dark regions might be interesting to analyze with a view to finding out whether the regions have some common characteristic properties.

For use in this analysis, the image in FIG. 6B is subjected to an image analysis by means of the colour processing system according to DK 174419 B1. As will be seen in FIG. 6B, the dark regions 4, 5, 6, 7 and 8 have now been converted into light regions, which are designated 4A, 5B, 6B, 7B and 8B in FIG. 6B (in the colour analysis the regions are yellow, which cannot be seen in FIG. 6B which is not coloured). In this case, the colour analysis has not given information in addition to that which may be derived from the original image. In particular, it is doubtful whether the region 6A has the same properties as the other regions.

The image in FIG. 6B has therefore been analyzed by means of the method according to the invention. The result of this is shown in FIG. 6C, which shows that the regions 4B, 5B, 7B and 8B now have a very dark appearance, while the region 6B has not been detected as a characteristic region by means of the method according to the invention.

It may thus be seen that the method of the invention allows detection and segmentation of characteristic regions in images, which have certain characteristic dark regions, and which are circular with good approximation.

If only the analysis result shown in FIG. 6B were available, the region 6A would be an uncertain region, since the presence of a small circular area within this region could not be ruled out, which was disproved in this case by the analysis according to the method.

Although the invention has been explained particularly in connection with the detection of dark regions from light regions, then, within the scope defined by the claims, nothing prevents also light regions from being analyzed from dark regions, of course, which may be useful if a negative of an image is to be analyzed, where precisely dark regions have been replaced by light regions, and vice versa.

1. A method of detecting and segmenting characteristic dark regions in an image which is represented by a plurality of pixels having positions (x,y), characterized by comprising the steps of:
a) defining a given pixel position (x,y) as the centre of circular regions having radii r₁ and r₂, respectively, and perimeters P₁ and P₂, respectively, where r₁ and r₂ may assume a large number of values, with r₂>r₁>0,
b) calculating V₁ for each value of r₁ as an average of grey tone numbers for all circle perimeters P₁ in the range 0 to r₁,
c) calculating V₂ as an average of grey tone numbers for all circle perimeters P₂ in the range r₁ to r₂,
d) selecting the value of r₁ which gives the greatest value of V₂−V₁ as the radius of the object,
e) repeating steps a) to d) for a plurality of pixel positions in the image.

2. A method according to claim 1, characterized by using the relation r₂=qr₁ between r₂ and r₁, where q is a number larger than 0.

3. A method according to claim 1 or 2, characterized by only accepting a given pixel position as the centre of a circular region if a value of V₂−V₁, has been found for this position which exceeds the corresponding values of all positions within said circular region, when these corresponding values are calculated according to steps a) to e) of claim 1, otherwise the method proceeds in a new position.

4. A method according to claims 1-2, characterized by determining the grey tone number of a given circle perimeter P₁, P₂ as a percentile of all grey tone values in the perimeter.

5. A method according to claims 1-4, characterized by weighting the percentile values of the individual circle perimeters relative to the perimeter length.

6. A method according to claims 1-4, characterized by using only values of V₂31 V₁ above a preselected value as the centre of a characteristic region.

7. A method according to claims 1-6, characterized by non-electing circular regions having V₂ values above a predetermined threshold value.

8. A method according to any one of claims 1-6, characterized by changing the pixel position determined by steps a) to e) as the centre of a circular region, to the centre of gravity of the grey tone centre of gravity of the circle.

9. A method according to claims 1-8, characterized by dividing the outer boundary of each characteristic region into sectors, and performing the steps a) to d) for the pixel values of each sector, and then using the maximum values of the individual sectors for defining an outer part of these characteristic regions.

10. Use of a method according to claims 1-9 for the analysis of details in a colour image having characteristic coloured regions.
